(19) United States
(12) Patent Application Publication
(10) Pub. No.: US 2026/0158375 A1
(43) Pub. Date: Jun. 11, 2026

(54) OPERATION INPUT DEVICE AND INFORMATION PROCESSING SYSTEM

(71) Applicant: SONY GROUP CORPORATION, TOKYO (JP)

(72) Inventors: DAISUKE YAMAMOTO, TOKYO (JP); YUSAKU KATO, TOKYO (JP); AKIHIRO NAKATA, TOKYO (JP); RYO IWAMURO, TOKYO (JP); YOSHIO GOTO, TOKYO (JP)

(21) Appl. No.: 18/708,624

(22) PCT Filed: May 19, 2022
(86) PCT No.: PCT/JP2022/020806

§ 371 Date: May 9, 2024

(30) Foreign Application Priority Data
Nov. 17, 2021 (JP) 2021-187216

(51) Int. Cl. A63F 13/24

(52) U.S. Cl. CPC A63F 13/24

(57) ABSTRACT

An object of the present disclosure is to provide a new technique for adjusting mobility of a movable member of an operation input device. The present disclosure provides an operation input device including: a movable member 101 that moves by a user operation; and a dielectric elastomer actuator 102 that controls mobility of the movable member 101. The dielectric elastomer actuator 102 can control the mobility to adjust a sense of resistance to movement of the movable member 101. In one embodiment, the dielectric elastomer actuator 102 may be configured to adjust a frictional force against movement of the movable member 101.

### TECHNICAL FIELD

The present disclosure relates to an operation input device and an information processing system including the operation input device.

### BACKGROUND ART

The operation input device may be used, for example, as a controller of a game machine or as an element of the controller. Furthermore, the operation input device may be used as an element of an information processing device such as a smartphone terminal.

Various techniques have been proposed for the operation input device. For example, Patent Document 1 below discloses an operation input device including: an actuator that has an operation button that can move about a rotation center line in response to a pressing operation by a user and has a contact portion on a side opposite to a side pressed by the user and a button drive member that contacts the contact portion of the operation button and applies a force in a direction opposite to a direction in which the operation button is pressed to the operation button; and a guide that defines a direction in which the button drive member moves, in which the button drive member is slidable along the guide.

### CITATION LIST

### Patent Document

Patent Document 1: WO 2019/142918 A

### SUMMARY OF THE INVENTION

### Problems to be Solved by the Invention

The operation input device includes a movable member operated by a user. If the mobility of the movable member can be adjusted, it is considered that various sensations can be presented to the user who performs operation input.

An object of the present disclosure is to provide a new technique for adjusting mobility of a movable member of an operation input device.

### Solutions to Problems

The present disclosure provides
an operation input device including:
a movable member that moves by a user operation; and
a dielectric elastomer actuator that controls mobility of the movable member.

The dielectric elastomer actuator may control the mobility to adjust a sense of resistance to movement of the movable member.

The dielectric elastomer actuator may be configured to adjust a frictional force against movement of the movable member.

The dielectric elastomer actuator may be configured to adjust a movable range of the movable member.

The operation input device may be able to adjust the mobility of the movable member in stages.

The movable member may be movable to change a position of the movable member with respect to a housing of the operation input device.

The operation input device may include a contact member that is in contact with or is disposed to be able to contact the movable member, and the dielectric elastomer actuator may control the mobility of the movable member via the contact member.

The contact member may be provided on a surface of the dielectric elastomer actuator.

The operation input device may include a motion detection sensor that detects a motion of the movable member.

The operation input device may output a signal generated on the basis of motion detection by the motion detection sensor as a signal related to an input operation.

The operation input device may be a button-type, wheel-type, ball-type, or joystick-type operation input device.

Further, the present disclosure provides
an information processing system including an operation input device including:
a movable member that moves by a user operation; and
a dielectric elastomer actuator that controls mobility of the movable member.

The information processing system may further include an information processing device configured to transmit a signal for controlling the mobility of the movable member to the operation input device.

### BRIEF DESCRIPTION OF DRAWINGS

FIG. 1A is a schematic diagram illustrating a configuration example of an operation input device according to the present disclosure.

FIG. 1B is a schematic diagram illustrating a configuration example of an operation input device according to the present disclosure.

FIG. 1C is a schematic diagram illustrating a configuration example of an operation input device according to the present disclosure.

FIG. 1D is a schematic diagram illustrating a configuration example of an operation input device according to the present disclosure.

FIG. 1E is a schematic diagram illustrating a configuration example of an operation input device according to the present disclosure.

FIG. 2 is a schematic diagram for explaining a principle of deformation of a dielectric elastomer actuator.

FIG. 3 is a schematic diagram for explaining a frictional force generated when a movable member moves.

FIG. 4 is a schematic diagram for explaining adjustment of a frictional force due to deformation of a dielectric elastomer actuator.

FIG. 5 is a schematic diagram illustrating a configuration example of an operation input device according to the present disclosure.

FIG. 6 is a schematic diagram for explaining a structure of a dielectric elastomer actuator that can be used in the present disclosure.

FIG. 7 is a schematic diagram for explaining a structure of a stack-type dielectric elastomer actuator.

FIG. 8 is a schematic diagram for explaining a structure of a stack-type dielectric elastomer actuator.

FIG. 9 is a schematic diagram for explaining a structure of a roll-type dielectric elastomer actuator.

FIG. 10 is a schematic diagram for explaining a structure of a roll-type dielectric elastomer actuator.

FIG. 11 is a schematic diagram illustrating a configuration example of an operation input device in which a roll-type dielectric elastomer actuator is adopted.

FIG. 12 is a schematic diagram illustrating a configuration example of a ball-type operation input device.

FIG. 13 is a schematic diagram illustrating a configuration example of a wheel-type operation input device.

FIG. 14A is a schematic diagram illustrating a configuration example of a stick-type operation input device.

FIG. 14B is a schematic diagram illustrating a configuration example of a stick-type operation input device.

FIG. 15 is a diagram for explaining a model used for FEM analysis.

FIG. 16 is a diagram for explaining a model used for FEM analysis.

FIG. 17 is a diagram illustrating simulation results by FEM analysis.

FIG. 18 is a diagram illustrating simulation results by FEM analysis.

FIG. 19A is a schematic diagram illustrating a configuration example of an operation input device according to the present disclosure.

FIG. 19B is a schematic diagram illustrating a configuration example of an operation input device according to the present disclosure.

FIG. 20A is a block diagram of an example of an information processing system according to the present disclosure.

FIG. 20B is a block diagram illustrating a configuration example of an information processing device included in an information processing system according to the present disclosure.

### MODE FOR CARRYING OUT THE INVENTION

Hereinafter, preferred modes for carrying out the present disclosure will be described. Note that the embodiments described below illustrate representative embodiments of the present disclosure, and the scope of the present disclosure is not limited only to these embodiments.

The present disclosure will be described in the following order.
1. Description of Present Disclosure
2. First Embodiment (Operation Input Device)
   (1) Configuration Example of Operation Input Device
   (1-1) Movable Member
   (1-2) DEA
   (1-2-1) Configuration Example 1 of DEA (Stack-Type DEA)
   (1-2-2) Configuration Example 2 of DEA (Roll-Type DEA)
   (1-3) Housing
   (1-4) Motion Detection Sensor
   (2) Modification (Cylindrical Dielectric Elastomer Actuator)
   (3) Modification (Ball-Type Operation Input Device)
   (4) Modification (Wheel-Type Operation Input Device)
   (5) Modification (Stick-Type Operation Input Device)
   (6) Modification (Mobility Control by Inclined Surface)
   (7) Modification (Adjustment of Movable Range)
   (8) Examples
3. Second Embodiment (Information Processing System)

### 1. Description of Present Disclosure

The operation input device may include a movable member for receiving a user operation. When the user operates the movable member, the user feels a sensation regarding, for example, slidability, rigidity, or the like of the movable member. If the sensation can be adjusted, various sensations can be presented to the user. For example, regarding the controller of the game machine, if the sensation can be adjusted according to the scene of the game, it is considered that more interesting or more exciting experience can be given to the user.

It is conceivable to control the mobility of the movable member in order to adjust the sensation received by the user in the operation of the movable member. Here, in a case where it takes time to control the mobility or in a case where an operation sound is generated in accordance with the control of the mobility, the user may feel uncomfortable. Therefore, it is considered desirable that the control is performed at high speed and in a quiet manner.

In addition, an operation input device such as a controller of a game machine is often used by a user holding the operation input device in a hand. In addition, an arrangement place of such an operation input device is often moved. Therefore, it is desirable to reduce the size and weight of the operation input device. In addition, since it is assumed that the operation input device is used for a relatively long time, power saving is also required.

The present inventors have found that the operational feeling given to the user can be adjusted at high speed and in a quiet manner by a specific operation input device. In addition, the specific operation input device is easily reduced in size and weight, and can adjust the operational feeling with a simple structure. In addition, since the structure of the specific operation input device is simple, the specific operation input device can be adopted in various types of operation input devices.

An operation input device of the present disclosure includes a movable member that moves by a user operation, and a dielectric elastomer actuator that controls mobility of the movable member. That is, the operation input device is configured such that the dielectric elastomer actuator controls the mobility of the movable member. The operation input device configured as described above can adjust an operational feeling at a high speed and in a quiet manner, and is easily reduced in size and weight. In addition, the dielectric elastomer actuator has a large deformation rate and a large generated energy per unit weight. Therefore, the operational feeling of the movable member can be efficiently controlled.

The operation input device of the present disclosure may be, for example, a button-type, a wheel-type, a ball-type, or a joystick-type operation input device, but is not limited thereto. Examples of these types are given below. Furthermore, since the operation input device of the present disclosure can give various sensations to the user, the operation input device may be used as, for example, a haptics device.

The dielectric elastomer actuator can control the mobility to adjust a sense of resistance to movement of the movable member. As a result, the user who operates the operation input device (particularly, the movable member) can feel various senses of resistance at the time of the operation, that is, can present various sensations (for example, tactile sensation and the like) to the user. For example, it is possible to give the user an interesting or exciting experience.

In one embodiment, the dielectric elastomer actuator may be configured to adjust a frictional force against movement of the movable member. That is, the mobility of the movable member may be adjusted by adjusting the frictional force.

In another embodiment, the dielectric elastomer actuator may be configured to adjust a movable range of the movable member. That is, the mobility of the movable member may be adjusted by adjusting the movable range.

Specific examples of the adjustment of mobility in these embodiments will be described below.

### 2. First Embodiment (Operation Input Device)

### (1) Configuration Example of Operation Input Device

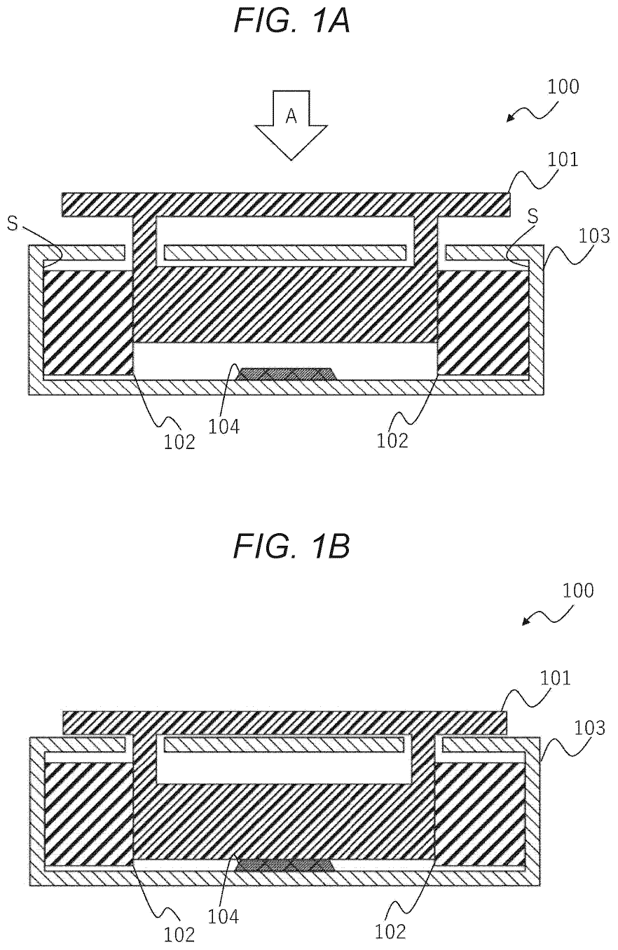

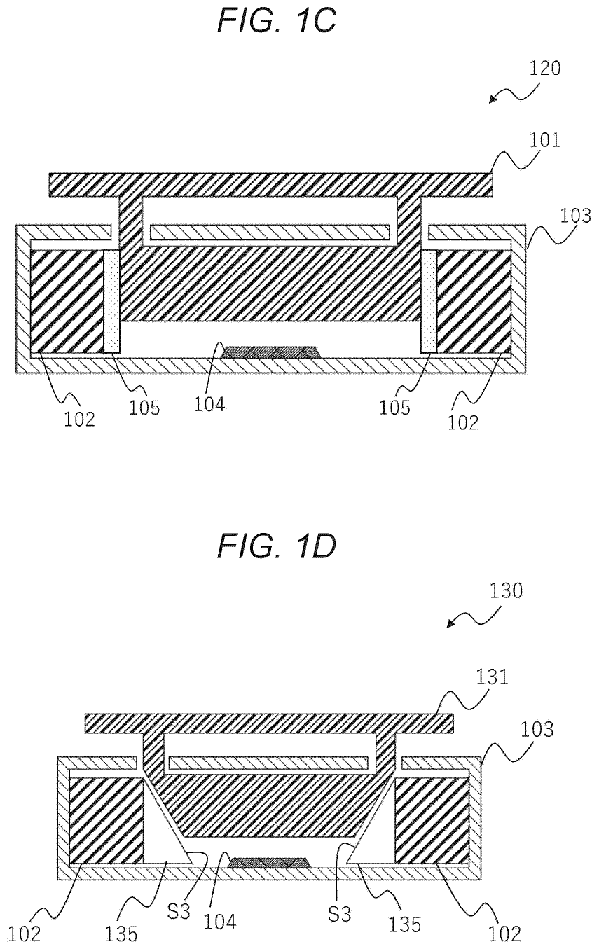

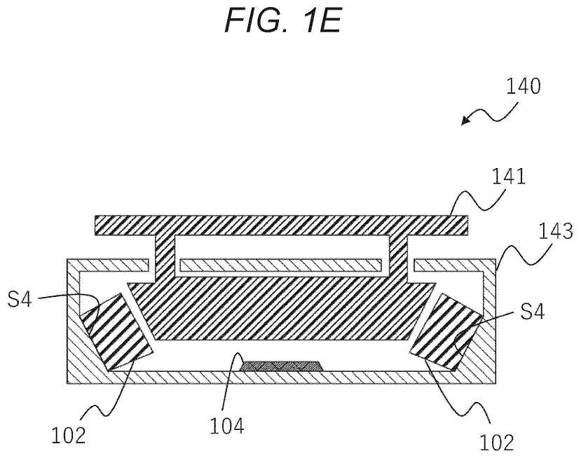

A configuration example of the operation input device according to the first embodiment will be described with reference to FIG. 1A. The drawing is a schematic cross-sectional view of the button-type operation input device 100. The operation input device includes a movable member 101 that receives a user's operation and a dielectric elastomer actuator (hereinafter also referred to as “DEA”) 102 that controls mobility of the movable member. The operation input device further includes a housing 103 in which the DEA 102 is housed and a motion detection sensor 104 that detects the motion of the movable member 101. These components will be described below.

### (1-1) Movable Member

The movable member 101 is configured to move in accordance with a user operation. The movable member 101 moves in the direction indicated by the arrow A, for example, in response to being pushed in the direction. As a result, the movable member 101 comes into contact with the motion detection sensor 104 as illustrated in FIG. 1B. That is, the movable member 101 can move such that the position of the movable member 101 with respect to the housing 103 of the operation input device 100 changes.

The motion detection sensor 104 detects the contact, converts the contact into, for example, an electric signal, and transmits the electric signal to an arbitrary information processing device or the like. The information processing device handles the electric signal as information indicating that an operation input has been performed by the user.

The movable member 101 may have, for example, a button shape, but the shape of the movable member 101 is not limited thereto, and may be appropriately set by those skilled in the art. In addition, the material of the movable member 101 may be, for example, a resin material or a rubber material, but is not limited thereto, and may be appropriately selected by those skilled in the art.

The operation input device 100 may further include an elastic member (not illustrated) that returns the movable member 101 moved by the operation input to the original position. The elastic member may be, for example, a spring, rubber, sponge, or the like, and may be particularly a spring. The elastic member may be configured to return the movable member 101 from the position illustrated in FIG. 1B to the position illustrated in FIG. 1A.

### (1-2) DEA

The DEA 102 includes a dielectric elastomer and an electrode pair that applies a voltage to the dielectric elastomer. When the voltage of the dielectric elastomer is applied by the electrode pair, the electrodes of the electrode pair attract each other, whereby the dielectric elastomer is deformed. Mobility of the movable member 101 is controlled by the deformation.

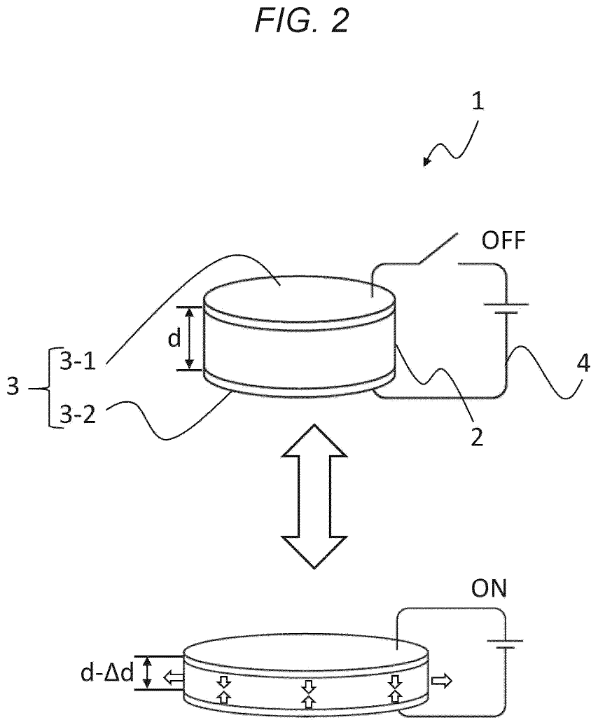

The principle of the deformation will be described with reference to FIG. 2. The drawing illustrates a schematic diagram of the DEA. The DEA 1 includes a dielectric elastomer 2 and an electrode pair 3. The electrode pair 3 is disposed so as to sandwich the dielectric elastomer 2, that is, one electrode 3-1 of the electrode pair 3, the dielectric elastomer 2, and the other electrode 3-2 are laminated in this order. The electrode pair 3 constitutes a part of a circuit 4.

As illustrated above in the drawing, in a case where the voltage of the circuit 4 is off, the dielectric elastomer 2 has a thickness d in a direction perpendicular to the surfaces of the two electrodes.

As illustrated in the lower part of the drawing, when the voltage of the circuit 4 is turned on, a voltage is applied between the two electrodes. As a result, the two electrodes are pulled against each other. As a result, the dielectric elastomer 2 contracts in the direction perpendicular to the electrode surface and extends in the in-plane direction. As a result, the thickness of the dielectric elastomer 2 in the direction perpendicular to the surfaces of the two electrodes changes to d−Δd.

The DEA 1 controls the mobility of the movable member using the deformation as described above. In addition, in order to secure desired mobility of the movable member, for example, a necessary deformation amount can be secured by laminating the basic structures illustrated in the drawing.

Here, regarding the contraction of the dielectric elastomer 2, the generated force and strain in the contraction direction can be expressed by the following formulas, where the applied voltage is V, the dielectric constant of the dielectric elastomer is ε, and the Young's modulus of the dielectric elastomer is Y.

$$Generated force P ∝ {ε ( \frac{V}{d} )}^{2} \qquad [ Math . 1 ]$$

$$Strain s ∝ \frac{ε}{Y} {( \frac{V}{d} )}^{2}$$

As can be seen from these formulas, the deformation amount and the generated force of the DEA can be adjusted by adjusting the voltage applied to the DEA.

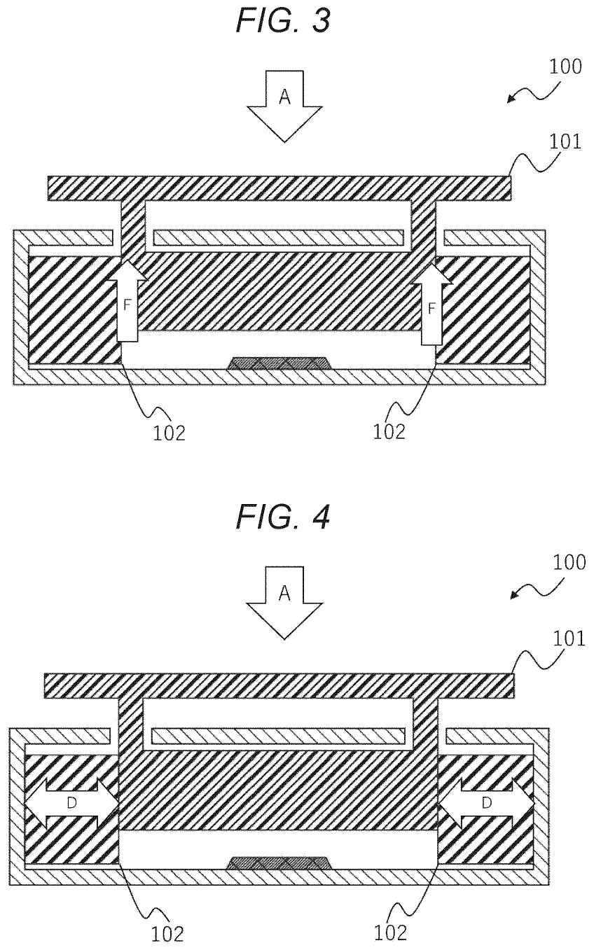

An example of the control of the mobility of the movable member 101 will be described below with reference to FIG. 3.

As described above, when the movable member 101 is pushed in the direction of the arrow A illustrated in FIG. 1A, the movable member 101 moves as illustrated in FIG. 1B. The movement brings the movable member 101 into contact with the motion detection sensor 104. Here, the DEA 102 is fixed to the inner surface S of the housing 103. Therefore, during the movement, the fixing position of the DEA 102 with respect to the housing 103 does not move. That is, the movable member 101 moves so as to slide on the DEA 102.

The movable member 101 included in the operation input device 100 is in contact with the DEA 102. Therefore, at the time of the movement of the movable member 101 described above, as illustrated in FIG. 3, a frictional force F with respect to the moving direction is generated between the movable member 101 and the DEA 102. The DEA 102 controls the frictional force by adjusting the deformation or contact pressure described above, thereby controlling the mobility of the movable member 101. The DEA 102 does not necessarily need to be deformed in order to control the frictional force. For example, the DEA 102 is assembled in a pre-distorted state in advance, and a voltage is applied to the DEA 102 to reduce the contact pressure between the DEA 102 and the movable member 101. This can reduce the frictional force between the DEA 102 and the movable member 101.

For example, as illustrated in FIG. 4, in a case where the DEA 102 is deformed (particularly extended) in the direction indicated by the arrow D by, for example, applying a voltage to the DEA 102, the contact pressure between the DEA 102 and the movable member 101 increases, and accordingly, the frictional force against the movement of the movable member 101 in the direction of the arrow A also increases. Therefore, the sense of resistance or rigidity felt when the movable member 101 is pushed is enhanced.

Conversely, in a case where the DEA 102 is deformed in the direction opposite to the arrow D, for example by releasing the application of the voltage to the DEA 102, the contact pressure between the DEA 102 and the movable member 101 decreases, and accordingly, the frictional force against the movement of the movable member 101 also decreases. Therefore, the sense of resistance or rigidity felt when the movable member 101 is pushed decreases.

Thus, in one embodiment of the present disclosure, the DEA may be configured to adjust a frictional force against movement of the movable member. That is, the DEA controls the mobility of the movable member by adjusting the frictional force. In this case, for example, for the adjustment, the DEA may be configured to deform (extend or contract) in a direction (for example, a vertical direction) intersecting the moving direction of the movable member.

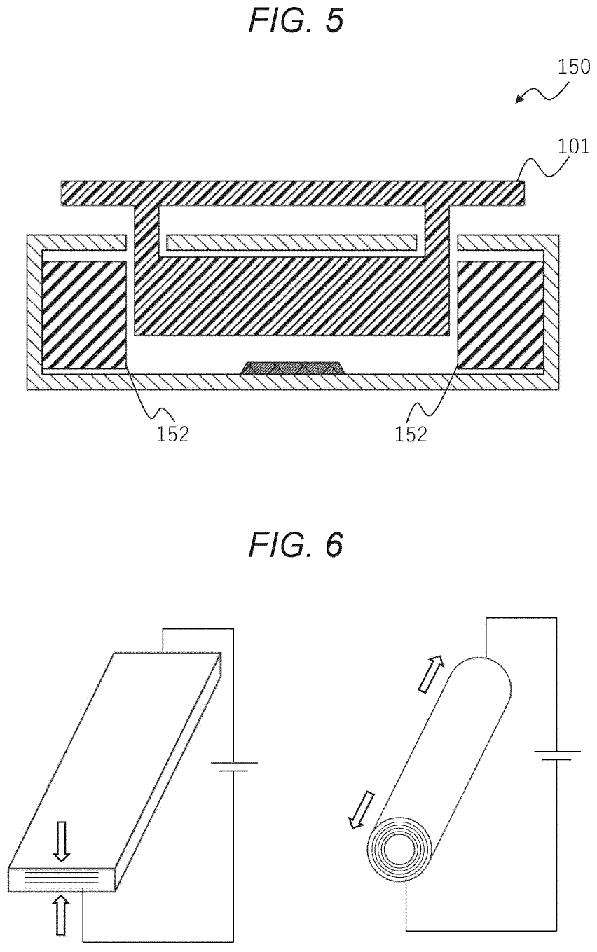

In addition, mobility may be adjusted by separating the DEA and the movable member from each other. For example, in the operation input device 150 illustrated in FIG. 5, a DEA 152 is separated from the movable member 101. Even when the movable member 101 is pushed in this state, no frictional force is generated between the movable member 101 and the DEA 152. Then, for example, when a voltage is applied, the DEA 102 is deformed and comes into contact with the movable member 101, and the operation input device 150 is in a state as illustrated in FIG. 1A, for example. In a case where the movable member 101 is pushed in this state, a sense of resistance felt when the movable member 101 is pushed increases due to the contact.

As described above, the operation input device of the present disclosure may be configured to adjust the frictional force with respect to the moving direction of the movable member by the presence or absence of contact between the DEA and the movable member.

The operation input device of the present disclosure may be able to adjust the mobility of the movable member in stages. In this regard, as described above, the generated force also changes by changing the magnitude of the applied voltage. Therefore, by adjusting the applied voltage in stages, the generated force also changes in stages, whereby the mobility of the movable member can be adjusted in stages. That is, the stage of mobility may be two or more. Further, the stage of mobility may include a stage where the movable member and the DEA are not in contact with each other.

In addition, the mobility of the movable member may be continuously adjusted. By continuously (that is, gradually) changing the applied voltage, the generated force also gradually changes. Thus, the mobility of the movable member can be continuously adjusted.

In one embodiment of the present disclosure, the DEA may be configured to control the mobility of the movable member via a contact member (hereinafter also referred to as a “surface member”). For example, a contact member may be provided on the surface of the DEA, and the contact member comes into contact with the movable member. By selecting the material of the contact member, the frictional force with the DEA can be adjusted. In addition, the contact member can prevent deterioration or wear of elements (for example, electrodes or the like) of the DEA.

This embodiment will be described with reference to FIG. 1C. The operation input device 120 illustrated in the drawing is the same as the operation input device 100 illustrated in FIG. 1A except that a contact member 105 is provided on the surface of the DEA.

The contact member 105 illustrated in the drawing is provided between the DEA 102 and the movable member 101. The contact member 105 is fixed to the surface of the DEA 102, and the positional relationship between the contact member 105 and the DEA 102 does not change even in a case where the movable member 101 moves. That is, the movable member 101 moves so as to slide on the surface of the contact member 105.

The material of the contact member 105 may be, for example, a resin material or a ceramic material, and the material of the contact member 105 may be appropriately selected by a person skilled in the art to provide a desired frictional force with the movable member. For example, the contact member may be a lightweight and high-strength material such as polycarbonate. As described above, in a preferred embodiment, the operation input device of the present disclosure may include a contact member that is in contact with or is disposed to be able to contact the movable member, and the operation input device may be configured such that the DEA controls the mobility of the movable member via the contact member.

The DEA 102 may be, for example, a stack-type, a roll-type, or a fiber-type DEA, and may be particularly a stack-type or a roll-type DEA.

Whether to utilize the extension of the DEA or the contraction of the DEA to increase the frictional force may be appropriately selected by those skilled in the art on the basis of factors such as, for example, the type of DEA adopted (such as a stack-type or a roll-type) and the required deformation amount.

From the viewpoint of securing the deformation amount, the DEA 102 is preferably a stack-type or roll-type DEA. The structures of these DEAs will be described below with reference to FIG. 6.

The stack-type DEA has a structure in which a laminate of an electrode layer and a dielectric elastomer layer is stacked. The stack-type DEA may be manufactured by applying an electrode material to a dielectric elastomer material to obtain the laminate, and then stacking the laminate multiple times. In a case where the stack-type DEA is adopted in the operation input device of the present disclosure, as illustrated on the left of the drawing, contraction deformation in the direction perpendicular to the laminating surface by application of a voltage may be used.

The roll-type DEA has a structure in which a laminate of an electrode layer and a dielectric elastomer layer is wound. The roll-type DEA may be manufactured by applying an electrode material to a dielectric elastomer material to obtain the laminate, then winding the laminate around, for example, a core material, and removing the core material after the winding. The roll-type DEA is deformed in the axial direction of the roll by application of a voltage. In a case where the roll-type DEA is adopted in the operation input device of the present disclosure, extension deformation in the axial direction of the cylinder by application of a voltage may be used as illustrated on the right side of the drawing.

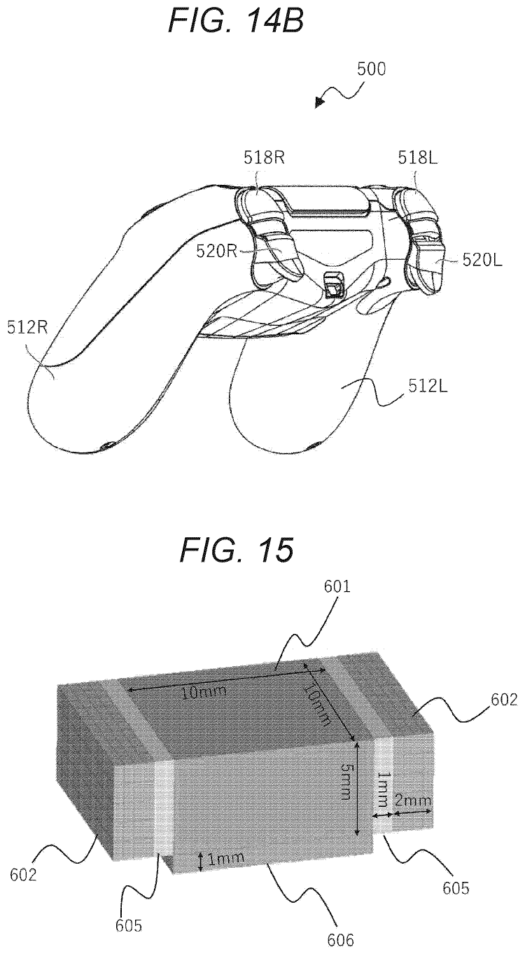

The operation input device according to the present disclosure may be configured as, for example, a controller of a game machine, or may be configured as one element (for example, one button unit) constituting the controller of the game machine. Examples of such a controller include, but are not limited to, a controller as described below with reference to FIGS. 14A and 14B in (5). According to the present disclosure, it is possible to control the mobility of the movable member at high speed and in a quiet manner. In addition, since the number of components required to control the mobility of the movable member according to the present disclosure is small, the device can be reduced in size and weight, and the device configuration can be simplified. These advantages are particularly noticeable in a case where the present disclosure is applied to a controller of a game machine.

Examples of DEAs available in the present disclosure are further described below.

### (1-2-1) Configuration Example 1 of DEA (Stack-Type DEA)

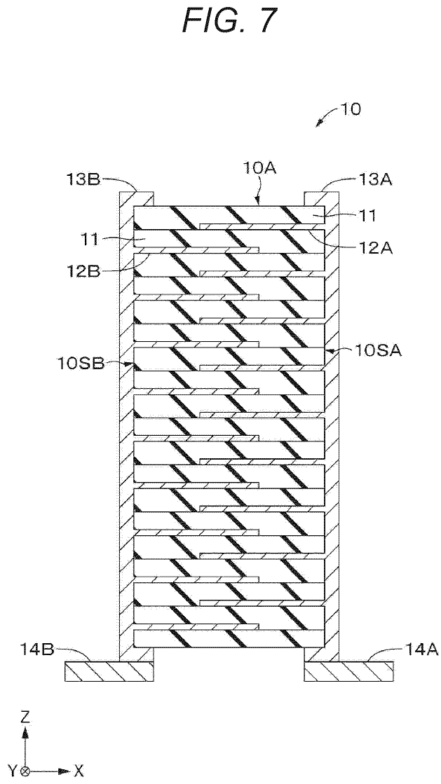

Hereinafter, an example of a configuration of a DEA usable in the present disclosure will be described with reference to FIG. 7. A DEA (hereinafter also referred to as an “actuator”) 10 illustrated in the drawing is a stack-type (also referred to as a laminated-type) DEA. The actuator 10 includes a laminate 10A, an external electrode 13A, an external electrode 13B, an extraction electrode 14A, and an extraction electrode 14B.

### (Laminate)

The laminate 10A is a main body of the actuator 10. The laminate 10A has a rectangular parallelepiped shape. The laminate 10A has a first side surface 10SA and a second side surface 10SB facing the first side surface 10SA. However, the shape of the laminate 10A is not limited thereto, and may be a cylindrical shape, an elliptical columnar shape, a prismatic shape, or the like. The laminate 10A includes a plurality of elastomer layers 11, a plurality of electrode layers 12A, and a plurality of electrode layers 12B. In the following description, in a case where the electrode layer 12A and the electrode layer 12B are collectively referred to without being particularly distinguished, they are referred to as the electrode layer 12. The plurality of elastomer layers 11 and the plurality of electrode layers 12 are laminated such that the elastomer layers 11 and the electrode layers 12 are alternately positioned.

In the present specification, first and second directions that are in-plane directions of the elastomer layer 11 and are orthogonal to each other are referred to as X and Y axis directions. In addition, a direction perpendicular to the main surface of the elastomer layer 11, that is, a laminating direction of the elastomer layer 11 and the electrode layer 12 is referred to as a Z axis direction. Note that, in a case where the elastomer layer 11 has a rectangular shape, the longitudinal direction of the elastomer layer 11 is referred to as an X axis direction, and the lateral direction (width direction) of the elastomer layer 11 is referred to as a Y axis direction. From the viewpoint of insulation properties, both end surfaces in the Z axis direction are preferably covered with the elastomer layer 11. The laminate 10A is configured to be displaceable in the Z axis direction by application of a drive voltage.

### (Elastomer Layer)

The elastomer layer 11 is a dielectric elastomer layer and has elasticity in an in-plane direction (X and Y axis directions) of the actuator 10. Each elastomer layer 11 is sandwiched between a set of electrode layers 12. The elastomer layer 11 is, for example, a sheet. Note that, in the present disclosure, the sheet is defined to include a film. Examples of the shape of the elastomer layer 11 in plan view include a polygonal shape such as a rectangular shape, a circular shape, an elliptical shape, and the like, but are not limited to these shapes. The elastomer layer 11 may be pre-distorted (that is, biaxially stretched) in the X and Y axis directions.

The elastomer layer 11 contains, for example, an insulating elastomer as an insulating stretchable material. The insulating elastomer includes, for example, at least one selected from the group consisting of a silicone-based resin, an acrylic resin, a urethane-based resin, and the like.

The elastomer layer 11 may contain an additive as necessary. The additive includes, for example, at least one selected from the group consisting of a crosslinking agent, a plasticizer, an anti-aging agent, a surfactant, a viscosity modifier, a reinforcing agent, a colorant, and the like.

The lower limit value of the average thickness of the elastomer layer 11 is preferably 1 μm or more. When the lower limit value of the average thickness of the elastomer layer 11 is 1 μm or more, handleability can be improved. The upper limit value of the average thickness of the elastomer layer 11 is preferably 20 μm or less. When the upper limit value of the average thickness of the elastomer layer 11 is 20 μm or less, a good displacement amount can be obtained at a low drive voltage.

The average thickness of the elastomer layer 11 described above is determined as follows. First, the actuator 10 is cut parallel to the Z axis direction (laminating direction) by cutting with a razor to expose a cross section, and Pt sputtering treatment with a thickness of about 2 nm is performed, and then the cross section of the test piece is observed with a scanning electron microscope (SEM). A device and an observation condition are described below.
Device: SEM (Helios G4 from Thermo Fisher)
Acceleration voltage: 5 kV
Magnification: 1000 times

Next, using the obtained SEM image, the thickness of the elastomer layer 11 is measured at positions of at least 10 points, and then the measured values are simply averaged (arithmetically averaged) to determine the average thickness of the elastomer layer 11. Note that the measurement positions are selected at random from the test piece.

The Young's modulus of the elastomer layer 11 is preferably equal to or less than the Young's modulus of the electrode layer 12. When the Young's modulus of the elastomer layer 11 is equal to or less than the Young's modulus of the electrode layer 12, the displacement amount of the actuator 10 can be improved. The lower limit value of the Young's modulus of the elastomer layer 11 is preferably 0.05 MPa or more. When the lower limit value of the Young's modulus of the elastomer layer 11 is 0.05 MPa or more, the handleability of the elastomer layer 11 can be improved. The upper limit value of the Young's modulus of the elastomer layer 11 is preferably 5 MPa or less. When the upper limit value of the Young's modulus of the elastomer layer 11 is 5 MPa or less, a good displacement amount can be obtained at a low drive voltage.

The Young's modulus of the elastomer layer 11 described above is determined as follows. The interface between the elastomer layer 11 and the electrode layer 12 is peeled off, and the elastomer layer 11 is taken out. Subsequently, the tensile properties of the elastomer layer 11 are determined in accordance with JIS K 6251:2010, and then the Young's modulus of the elastomer layer 11 is determined from the ratio of the tensile stress in the range in which the stress linearly changes with respect to the strain (that is, a range in which a linear response is obtained) to the strain corresponding thereto. The tensile properties described above are measured under an environment of a temperature of 25° C. and a humidity of 50% RH. Note that, unless otherwise specified, each measurement described below is also performed under an environment of a temperature of 25° C. and a humidity of 50% RH.

### (Electrode)

The electrode layer 12 has elasticity in an in-plane direction (X and Y axis directions) of the actuator 10. As a result, the electrode layer 12 can extend and contract following the extension and contraction of the elastomer layer 11. The elastomer layer 11 is sandwiched between the electrode layers 12 adjacent to each other in the Z axis direction. The electrode layers 12 overlap each other in the Z axis direction. Examples of the shape of the electrode layer 12 in plan view include a polygonal shape such as a rectangular shape, a circular shape, an elliptical shape, and the like, but are not limited to these shapes.

The electrode layer 12 contains carbon black and a binder. Carbon black is a conductive material for imparting conductivity to the electrode layer 12. Carbon black is a so-called conductive carbon black. The content of carbon black in the electrode layer 12 is preferably 10 mass % or more. When the content of carbon black in the electrode layer 12 is 10 mass % or more, the conductivity of the electrode layer 12 can be improved. The content of carbon black in the electrode layer 12 is preferably 20 mass % or less. In a case where the content of carbon black in the electrode layer 12 exceeds 20 mass %, the amount of the binder in the electrode layer 12 is excessively reduced, and sufficient interlayer adhesion may not be obtained between the elastomer layer 11 and the electrode layer 12.

The content of carbon black in the electrode layer 12 described above is determined as follows. The interface between the elastomer layer 11 and the electrode layer 12 is peeled off, and the electrode layer 12 is taken out. In a case where peeling is difficult, the surface is cut out by a surface and interfacial cutting analysis system (SAICAS) method, and a portion of the electrode layer 12 is recovered. After measuring the overall mass of the taken-out electrode layer 12, the silicone resin as a binder is dissolved by a MOF decomposition method (methyl orthoformate decomposition method) to recover an inorganic substance (carbon black). The mass of the inorganic substance is measured, and the carbon content in the electrode layer 12 is calculated from the values of the total mass and the inorganic substance mass.

The specific surface area of the carbon black is preferably 380 g/m² or more. When the specific surface area is less than 380 g/m², the number of contacts between carbon blacks decreases, so that the conductivity of the electrode layer 12 may decrease. The specific surface area of the carbon black is preferably 800 m²/g or less. When the specific surface area is more than 800 m²/g, carbon black is easily aggregated, and the smoothness of the surface of the electrode layer 12 is deteriorated.

The specific surface area of the carbon black described above is determined as follows. Carbon black is recovered from the electrode layer 12 in a manner similar to the method for determining the content of carbon black in the electrode layer 12 described above. The specific surface area of the recovered carbon black is determined by the BET method. Specifically, the specific surface area is measured in accordance with JIS K 6217-2. A measuring device and a measuring condition are described below.
Measuring device: BELSORP-max2 manufactured by MicrotracBEL Corporation
Measured adsorbate: N₂ gas
Measurement pressure range (p/p0): 0.01 to 0.99

The carbon black preferably has a porous structure. When the carbon black has a porous structure, the specific surface area of the carbon black can be increased. Therefore, the conductivity of the electrode layer 12 can be improved. The carbon black contains, for example, at least one selected from the group consisting of Ketjen black and acetylene black.

The binder has elasticity. The binder is preferably an insulating elastomer. The insulating elastomer includes, for example, at least one selected from the group consisting of a silicone-based resin, an acrylic resin, a urethane-based resin, and the like.

The electrode layer 12 may further contain an additive as necessary. As the additive, those similar to the elastomer layer 11 can be exemplified. Since the dispersant may adversely affect the characteristics of the electrode layer 12, it is preferable that the electrode layer 12 does not contain a dispersant as an additive.

The electrical resistivity of the electrode layer 12 is preferably 30.0 Ωcm or less, and more preferably 25.8 Ωcm or less. When the electrical resistivity of the electrode layer 12 is 30.0 Ωcm or less, good operation responsiveness can be obtained. The lower limit value of the electric resistivity of the electrode layer 12 is preferably 0.1 Ωcm or more, and more preferably 0.9 Ωcm or more. When the electrical resistivity of the electrode layer 12 is 0.1 Ωcm or more, an excessive decrease in the amount of the binder in the electrode layer 12 can be suppressed, so that sufficient interlayer adhesion can be obtained between the elastomer layer 11 and the electrode layer 12.

The electrical resistivity of the electrode layer 12 described above is determined as follows. A sample in which the surface of the electrode layer 12 is exposed is obtained by peeling or removing a part of the laminate 10A or the like. Thereafter, the sample is cut so that the electrode layer 12 has a rectangular shape of width 10 mm×length 50 mm to obtain an evaluation sample. However, in a case where it is difficult to take out the sample in the above size, it is assumed that the sample is taken out in a size that can be taken out.

Subsequently, the direct current resistance of the electrode layer 12 of the evaluation sample described above is measured using a digital multimeter 117 manufactured by FLUKE Corporation, and the electrical resistivity is calculated.

The average thickness of the electrode layer 12 is preferably 0.5 μm or more, and more preferably 1 μm or more. When the average thickness of the electrode layer 12 is 0.5 μm or more, good operation responsiveness can be obtained, and good interlayer adhesion can be obtained between the elastomer layer 11 and the electrode layer 12. The upper limit value of the average thickness of the elastomer layer 11 is preferably 20 μm or less, and more preferably 10 μm or less. When the upper limit value of the average thickness of the elastomer layer 11 is 20 μm or less, a good displacement amount can be obtained.

The average thickness of the electrode layer 12 described above is determined by a method similar to the average thickness of the elastomer layer 11 described above.

The Young's modulus of the electrode layer 12 is preferably 0.1 MPa or more. When the Young's modulus of the electrode layer 12 is 0.1 MPa or more, handleability can be improved. The Young's modulus of the electrode layer 12 is preferably 5 MPa or less. When the Young's modulus of the electrode layer 12 is 5 MPa or less, a good displacement amount can be obtained.

The Young's modulus of the electrode layer 12 described above is determined in a manner similar to the method for determining the Young's modulus of the elastomer layer 11 except that the interface between the elastomer layer 11 and the electrode layer 12 is peeled off and the electrode layer 12 is taken out.

### (External Electrode)

The external electrode 13A is for electrically connecting the plurality of electrode layers 12A. The external electrode 13A preferably has elasticity in the Z axis direction. As a result, it is possible to deform following the extension and contraction of the laminate 10A. The external electrode 13A is provided on the first side surface 10SA of the laminate 10A. End portions of the plurality of electrode layers 12A are connected to the external electrode 13A.

The external electrode 13B is for electrically connecting the plurality of electrode layers 12B. The external electrode 13B preferably has elasticity in the Z axis direction. As a result, it is possible to deform following the extension and contraction of the laminate 10A. The external electrode 13B is provided on the second side surface 10SB of the laminate 10A. Each end portion of the plurality of electrode layers 12B is connected to the external electrode 13B.

The external electrodes 13A and 13B contain a conductive material. As the conductive material, those similar to the electrode layers 12A and 12B can be exemplified. The external electrodes 13A and 13B may contain a binder having elasticity as necessary. The binder is preferably an elastomer. As the elastomer, an elastomer similar to the elastomer layer 11 can be exemplified.

### (Extraction Electrode)

The extraction electrodes 14A and 14B are for connecting the actuator 10 to a voltage source included in the electronic device. The extraction electrode 14A is connected to the external electrode 13A. The extraction electrode 14B is connected to the external electrode 13B. The extraction electrodes 14A and 14B are constituted by metal, for example.

### (Displacement Rate of Actuator)

The displacement rate of the actuator 10 in the laminating direction when the drive voltage 300 V is applied is preferably 0.5% or more, more preferably 1.0% or more. When the displacement rate in the laminating direction is within the above numerical range, the mobility of the movable member by the actuator 10 can be more efficiently controlled.

The displacement rate described above is obtained by the following formula.

$$Displacement rate [ \% ] = ( ( D 2 - D 1 ) / D 1 ) \times 100$$

(Where, the reference signs in the formula represent the following. D1: thickness of actuator 10 when drive voltage is not applied, D2: thickness of actuator 10 when drive voltage 300 V is applied)

Note that the thickness D1 of the actuator 10 is measured by a contact film thickness measuring device manufactured by Mitutoyo Corporation. D2−D1 is measured by a distance change between the actuator surface and the displacement meter at the time of voltage application using a laser displacement meter LK-G500 manufactured by KEYENCE CORPORATION.

### [Operation of Actuator]

Hereinafter, an example of the operation of the actuator 10 will be described.

When a drive voltage is applied between the electrode layers 12A and 12B, an attractive force due to a Coulomb force acts between the electrode layers 12A and 12B sandwiching the elastomer layer 11 therebetween. Therefore, the elastomer layer 11 is compressed and thinned in the thickness direction (Z axis direction) thereof. Therefore, the actuator 10 contracts in the Z axis direction.

On the other hand, when the drive voltage applied between the electrode layers 12A and 12B sandwiching the elastomer layer 11 is released, the attractive force due to the Coulomb force does not act between the electrode layers 12A and 12B. Therefore, the compression is released, and the elastomer layer 11 returns to the original thickness. Therefore, the actuator 10 expands in the Z axis direction.

As described above, in the actuator 10 according to the first embodiment, the actuator 10 can be displaced in the Z axis direction by applying and releasing the drive voltage between the electrode layers 12A and 12B. Note that the default state (initial state) of the actuator 10 may be a state in which a predetermined voltage is applied to the actuator 10 in advance, or may be a state in which no voltage is applied to the actuator 10.

### [Method of Manufacturing Actuator]

Hereinafter, an example of a method of manufacturing the actuator 10 will be described.

### (Conductive Paste Preparing Step)

A conductive coating material is prepared by adding and dispersing carbon black and a binder in a solvent. At this time, an additive may be further added to the solvent as necessary. The conductive paint may be a conductive ink or a conductive paste.

As the dispersion method, it is preferable to use stirring, ultrasonic dispersion, bead dispersion, kneading, homogenizer treatment, and the like. These dispersion methods may be used singly or in combination of two or more kinds thereof. The solvent is not particularly limited as long as it can disperse the elastomer. Examples of solvents include water, ethanol, methyl ethyl ketone, isopropanol alcohol, acetone, anone (cyclohexanone, cyclopentanone), hydrocarbon (hexane), amide (DMF), sulfide (DMSO), butyl cellosolve, butyl triglycol, propylene glycol monomethyl ether, propylene glycol monoethyl ether, ethylene glycol monoethyl ether, ethylene glycol monopropyl ether, ethylene glycol monoisopropyl ether, diethylene glycol monobutyl ether, diethylene glycol monoethyl ether, diethylene glycol monomethyl ether, diethylene glycol diethyl ether, dipropylene glycol monomethyl ether, tripropylene glycol monomethyl ether, propylene glycol monobutyl ether, propylene glycol isopropyl ether, dipropylene glycol isopropyl ether, tripropylene glycol isopropyl ether, methyl glycol, terpineol, and butyl carbitol acetate. These solvents may be used singly or in combination of two or more kinds thereof.

### (Electrode Forming Step)

Next, a conductive paint is applied onto the elastomer layer 11 to form the electrode layer 12. Thus, an electrode sheet is obtained. As a method for applying the coating material for electrode formation, screen printing, intaglio printing, or relief printing is preferable.

### (Lamination Step)

Next, after the two electrode sheets are superimposed, the two electrode sheets are bonded to each other by hot pressing. By repeating this step, a laminate 10A in which a plurality of electrode sheets is laminated is obtained. However, the lamination step is not limited to the above step, and for example, the laminate 10A may be obtained by laminating all the electrode sheets and then performing hot pressing.

### (External Electrode Forming Step)

Next, an electrode paste is applied to the first side surface 10SA and the second side surface 10SB of the laminate 10A to form the external electrodes 13A and 13B. Next, the extraction electrodes 14A and 14B are connected to the external electrodes 13A and 13B, respectively. As a result, the actuator 10 illustrated in FIG. 1 is obtained.

### Operations and Effects

As described above, the actuator 10 includes the plurality of elastomer layers 11 and the plurality of electrode layers 12, and the elastomer layers 11 and the electrode layers 12 are alternately laminated. As a result, a high displacement amount can be obtained at a low voltage.

Since the electrode layer 12 contains carbon black as the conductive particles, the actuator 10 can be reduced in weight. In addition, the cost of the actuator 10 can be reduced as compared with a case where the electrode layer 12 contains carbon nanotubes (CNT) or metal nanoparticles as conductive particles.

In a preferred embodiment, the content of carbon black in the electrode layer 12 is 10 mass % or more and 20 mass % or less, and the specific surface area of carbon black is 380 g/m² or more and 800 m²/g or less. As a result, it is possible to obtain the actuator 10 in which the interlayer adhesion of the lamination interface, the conductivity of the electrode layer 12, and the smoothness of the electrode layer 12 are favorable.

When the interlayer adhesion of the lamination interface is good, the actuator 10 having excellent operation characteristics and a good yield is obtained. When the conductivity of the electrode layer 12 is good, the actuator 10 having excellent responsiveness is obtained. When the smoothness of the electrode layer 12 is favorable, the actuator 10 having an excellent withstand voltage is obtained.

When the interlayer adhesion at the lamination interface is good, the interlayer adhesion at the lamination interface can be secured without separately providing a binder layer between the electrode layer 12 and the elastomer layer 11. This facilitates thin film lamination, so that a high displacement amount can be secured at a low voltage.

When the specific surface area of the carbon black is 800 m²/g or less, dispersibility of the carbon black can be secured without a dispersant. That is, the electrode layer 12 having good smoothness can be obtained without adding a dispersant. Since the dispersant may adversely affect the characteristics of the electrode layer 12, it is preferable that the electrode layer 12 does not contain the dispersant.

In a case where the electrode layer 12 contains a silicone-based resin as a binder, it is possible to obtain the electrode layer 12 that is flexible and has good heat resistance and chemical stability.

### [Modifications]

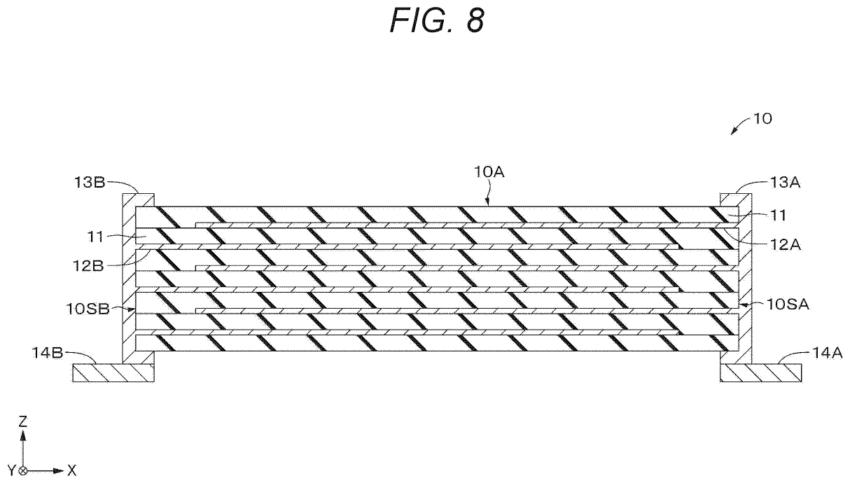

Although the example in which the actuator 10 is configured to be displaceable in the Z axis direction (see FIG. 7) has been described above, the actuator 10 may be configured to be displaceable in the X axis direction and the Y axis direction as illustrated in FIG. 8.

### (1-2-2) Configuration Example 2 of DEA (Roll-Type DEA)

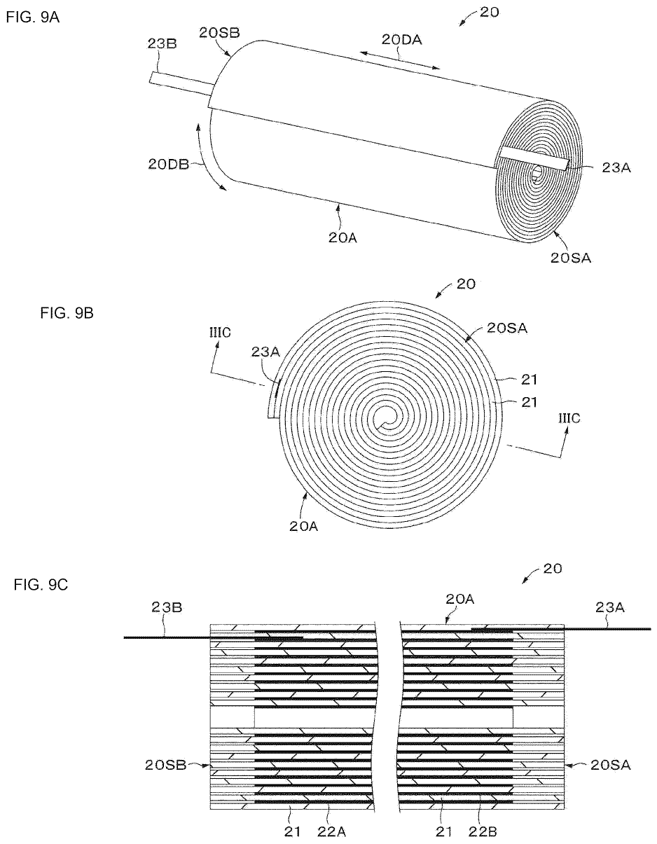

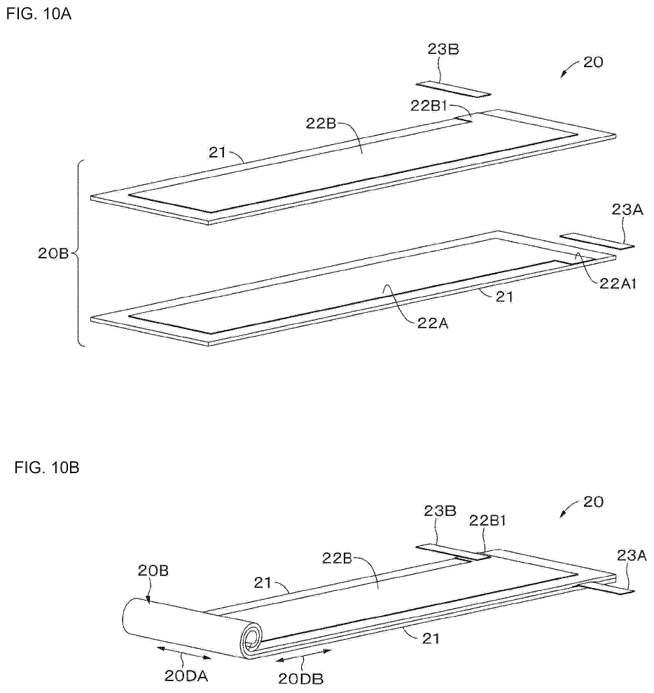

Other examples of DEAs available in the present disclosure are described below with reference to FIGS. 9A to 9C and FIGS. 10A and 10B. A DEA (hereinafter also referred to as an actuator) 20 illustrated in the drawing is a roll-type DEA. The actuator 20 includes a wound body 20A, an extraction electrode 23A, and an extraction electrode 23B.

The wound body 20A may have a substantially cylindrical shape. The wound body 20A is a main body of the actuator 20, and includes a wound laminate 20B. The laminate 20B includes two elastomer layers 21 and two electrode layers 22A and 22B. In the following description, the electrode layer 22A and the electrode layer 22B will be referred to as an electrode layer 22 in a case where they are collectively referred without being particularly distinguished.

The two elastomer layers 21 and the two electrode layers 22 are laminated such that the elastomer layers 21 and the electrode layers 22 are alternately positioned. More specifically, the elastomer layer 21, the electrode layer 22A, the elastomer layer 21, and the electrode layer 22B are laminated in this order.

### (Elastomer Layer)

The elastomer layer 21 has a band shape and is configured to be windable in the longitudinal direction. The elastomer layer 21 may be similar to the elastomer layer 11 in the stack-type DEA described above, and the description of the elastomer layer 11 also applies to the elastomer layer 21. The elastomer layer 21 may be pre-distorted (that is, biaxially stretched) in the central axis direction 20DA and the circumferential direction 20DB of the wound body 20A.

### (Electrode Layer)

The electrode layer 22A is sandwiched between the two elastomer layers 21 in the unwound state. The electrode layer 22A has a band shape and can be wound in the longitudinal direction. The electrode layer 22A has an extended portion 22A1. The extended portion 22A1 is extended from one long side of the electrode layer 22A. The electrode layer 22A may be similar to the electrode layer 12A in the stack-type DEA described above, and the description regarding the electrode layer 12A also applies to the electrode layer 22A.

The electrode layer 22B is provided on the elastomer layer 21 on the inner side of the wound body 20A at the time of winding. The electrode layer 22B has a band shape and can be wound in the longitudinal direction. The electrode layer 22B has an extended portion 22B1. The extended portion 22B1 extends from the other long side of the electrode layer 22B. The electrode layer 22B may be similar to the electrode layer 12B in the stack-type DEA described above, and the description regarding the electrode layer 12B also applies to the electrode layer 22B.

### (Extraction Electrode)

The extraction electrodes 23A and 23B are for connecting the actuator 20 to a voltage source of the operation input device. The extraction electrode 23A may protrude from one end surface 20SA of the wound body 20A. The extraction electrode 23A may be electrically connected to the extended portion 22A1 by, for example, welding or the like. The extraction electrode 23B may protrude from the other end surface 20SB of the wound body 20A. The extraction electrode 23B may be electrically connected to the extended portion 22B1 by, for example, welding or the like.

FIGS. 9 and 10 illustrate an example in which the extraction electrodes 23A and 23B protrude from the outer peripheral side of the wound body 20A, but the position where the extraction electrodes 23A and 23B protrude is not limited to this example, and may protrude from an arbitrary position (for example, the inner peripheral side) of the wound body 20A.

### [Operation of Actuator]

Hereinafter, an example of the operation of the actuator 20 will be described.

When a drive voltage is applied between the electrode layers 22A and 22B, the elastomer layer 21 sandwiched between the electrode layers 22A and 22B is compressed and thinned in the thickness direction thereof. As a result, the actuator 20 extends in the central axis direction 20DA of the wound body 20A.

On the other hand, when the drive voltage applied between the electrode layers 22A and 22B is released, the elastomer layer 21 sandwiched between the electrode layers 22A and 22B returns to the original thickness. As a result, the actuator 20 contracts in the central axis direction 20DA of the wound body 20A.

### [Operations and Effects]

The actuator 20 can obtain operations and effects similar to the actuator 10.

### (1-3) Housing

The housing 103 accommodates the movable member 101, the DEA 102, and the motion detection sensor 104. A material and a structure of the housing 103 may be appropriately selected by those skilled in the art. The housing 103 may be formed by, for example, a resin material.

### (1-4) Motion Detection Sensor

The motion detection sensor 104 may be configured to detect that the movable member 101 has moved. For example, the motion detection sensor 104 may be configured to detect that the movable member 101 has come into contact, or may be configured to detect that the movable member 101 has approached a predetermined distance. The motion detection sensor 104 may be configured to generate a predetermined signal (in particular, an electric signal) in response to contact of the movable member 101. The operation input device 100 outputs a signal generated on the basis of the motion detection by the motion detection sensor 104 as a signal related to the input operation. The type of such a motion detection sensor 104 may be appropriately selected by those skilled in the art.

### (2) Modification (Cylindrical Dielectric Elastomer Actuator)

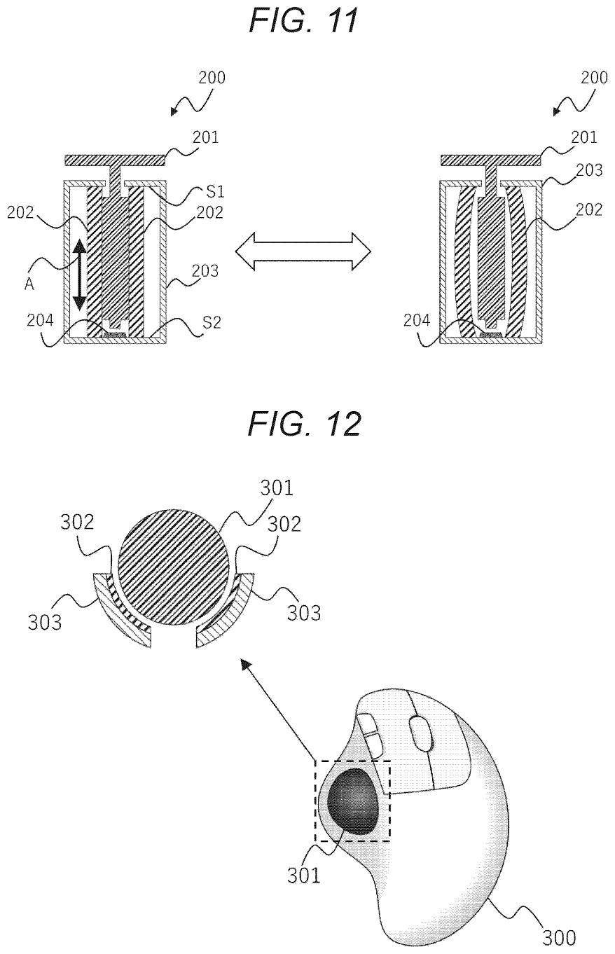

In a case where a roll-type DEA is adopted as the DEA included in the operation input device of the present disclosure, the operation input device may be configured such that the mobility of the movable member is controlled by displacement of the inner diameter of the DEA. This example will be described below with reference to FIG. 11.

A schematic cross-sectional view of the operation input device 200 according to the present disclosure is illustrated on the left of the drawing. The operation input device 200 includes a movable member 201 that receives a user operation and a dielectric elastomer actuator (hereinafter also referred to as DEA) 202 that controls mobility of the movable member. The operation input device further includes a housing 203 in which the DEA 202 is housed and a motion detection sensor 204 that detects the motion of the movable member 201. These components will be described below.

The DEA 202 is a roll-type DEA, and is configured to control mobility of the movable member 201 using displacement of an inner diameter of the roll. The movable member 201 is disposed in a hollow portion of the DEA 202. The description regarding the DEA 101 in (1) above (particularly, the description regarding the roll-type DEA) also applies to the DEA 202.

The DEA 202 is fixed to two inner surfaces S1 and S2 inside the housing 203. The DEA 202 is configured to extend in a direction of an arrow A in the drawing (axial direction of the cylinder) by application of a voltage.

On the left of the drawing, no voltage is applied to the DEA 202. In this case, the DEA 202 is in contact with the movable member 201.

When a voltage is applied to the DEA 202, the DEA extends in the direction of arrow A in the drawing. However, the distance between the inner surfaces S1 and S2 is constant and the DEA 202 is fixed to the inner surfaces S1 and S2. Therefore, as illustrated on the right side of the drawing, the inner diameter of the DEA 202 is displaced. That is, the application of the voltage increases the inner diameter of the DEA 202, whereby the DEA 202 does not come into contact with the movable member 201 (or the contact pressure between the DEA 202 and the movable member 201 decreases). Therefore, friction between the movable member 201 and the DEA 202 does not occur (or the frictional force decreases), and a sense of resistance at the time of operating the movable member 201 decreases.

### (3) Modification (Ball-Type Operation Input Device)

In one embodiment, the operation input device of the present disclosure may be a ball-type operation input device. That is, the ball operated by the user corresponds to the movable member described above. Then, the DEA may be configured to control the mobility of the ball. This embodiment will be described with reference to FIG. 12.

In the drawing, a mouse 300 is illustrated as an example of an operation input device according to the present disclosure. The mouse 300 includes a tracking ball 301 as a movable member. A user operation is input in response to the user operating tracking ball 301.

As illustrated in the drawing, mobility of the tracking ball 301 is controlled by a DEA 302. The DEA 302 is fixed to a housing 303 for holding the tracking ball 301. In response to the application of the voltage to the DEA 302, the DEA 302 is deformed, thereby changing the contact state with the tracking ball 301.

For example, when a voltage is applied to the DEA 302, the DEA 302 comes into contact with the tracking ball 301, or the contact pressure between the DEA 302 and the tracking ball 301 increases, and the sense of resistance to the rotational movement of the tracking ball 301 increases. In addition, when the application of the voltage is released, the DEA 302 does not come into contact with the tracking ball 301, or the contact pressure between the DEA 302 and the tracking ball 301 decreases, and the sense of resistance to the rotational movement of the tracking ball 301 decreases. Conversely, when the application of the voltage to the DEA 302 is released, the DEA 302 may contact the tracking ball 301, or the contact pressure between the DEA 302 and the tracking ball 301 may be increased, which may enhance the sense of resistance to rotational movement of the tracking ball 301. Further, when the voltage is applied, the DEA 302 may not come into contact with the tracking ball 301, or the contact pressure between the DEA 302 and the tracking ball 301 may decrease, and the sense of resistance to the rotational movement of the tracking ball 301 may decrease.

In this manner, the mobility of the tracking ball 301 may be controlled by controlling the voltage application to the DEA 302.

Note that the mobility of the tracking ball may be controlled by controlling the frictional force between the tracking ball and the DEA as described above, but for example, the mobility of other components (a movable member for converting the motion of the tracking ball into an electrical signal, such as a gear member or a rotary encoder) moving according to the movement of the tracking ball may be controlled by the DEA.

### (4) Modification (Wheel-Type Operation Input Device)

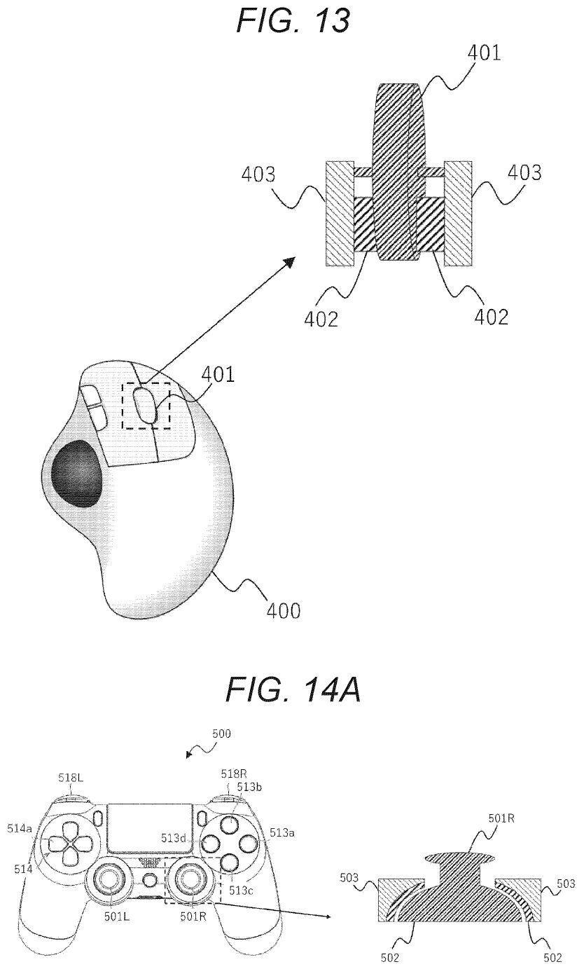

In one embodiment, the operation input device of the present disclosure may be a wheel-type operation input device. That is, the wheel operated by the user corresponds to the movable member described above. Then, the DEA may be configured to control the mobility of the wheel. This embodiment will be described with reference to FIG. 13.

In the drawing, a mouse 400 is illustrated as an example of an operation input device according to the present disclosure. The mouse 400 includes a wheel 401 as a movable member. A user operation is input in response to the user operating the wheel 401.

As illustrated in the drawing, mobility of the wheel 401 is controlled by a DEA 402. The DEA 402 is fixed to a housing 403 that houses the wheel 401. In response to the application of the voltage to the DEA 402, the DEA 402 is deformed, thereby changing the contact state with the wheel 401.

For example, when a voltage is applied to the DEA 402, the DEA 402 comes into contact with the wheel 401, or the contact pressure between the DEA 402 and the wheel 401 increases, and the sense of resistance to the rotational movement of the wheel 401 increases. In addition, when the application of the voltage is released, the DEA 402 does not come into contact with the wheel 401, or the contact pressure between the DEA 402 and the wheel 401 decreases, and the sense of resistance to the rotational movement of the wheel 401 decreases.

Conversely, when the application of the voltage to the DEA 402 is released, the DEA 402 may come into contact with the wheel 401 or the contact pressure between the DEA 402 and the wheel 401 may be increased, which may enhance the sense of resistance to rotational movement of the wheel 401. Further, when a voltage is applied, the DEA 402 may not come into contact with the wheel 401, or the contact pressure between the DEA 402 and the wheel 401 may decrease, and the sense of resistance to the rotational movement of the wheel 401 may decrease.

In this manner, the mobility of the wheel 401 may be controlled by controlling the voltage application to the DEA 402.

### (5) Modification (Stick-Type Operation Input Device)

In one embodiment, the operation input device of the present disclosure may be a stick-type operation input device. That is, the stick operated by the user corresponds to the movable member described above. Then, the DEA may be configured to control the mobility of the stick. This embodiment will be described with reference to FIGS. 14A and 14B.

In the drawing, a game controller 500 is illustrated as an example of an operation input device according to the present disclosure. The controller 500 includes analog sticks 501R and 501L as movable members. The analog sticks 501R and 501L can be inclined in the front-back direction, the left-right direction, and an oblique direction with respect to the front-back direction and the left-right direction. A user operation is input in response to the user operating the analog sticks 501R and 501L.

As illustrated in the drawing, mobility of the analog stick 501R is controlled by a DEA 502. The DEA 502 is fixed to a housing 503 of the controller 500. In response to the application of the voltage to the DEA 502, the DEA 502 is deformed, thereby changing the contact state with the analog stick 501R. Accordingly, the DEA 502 controls the mobility of the analog stick 501R. The mobility of the analog stick 501L is similarly controlled.

The stick-type operation input device is not limited to the analog stick illustrated in the drawing, and may be, for example, a joystick used in a flight simulator or the like.

Note that the operation input device 500 illustrated in FIG. 14A has a plurality of operation members on its upper surface. For example, four operation buttons 513a to 513d are provided on the right part of the upper surface of the operation input device 500. In addition, a cross key 514 having four protrusions 514a is provided on the left part of the upper surface of the operation input device 500.

In addition, as illustrated in FIGS. 14A and 14B, an operation button 8R and an operation button 20R are provided on the right part of the front surface, and an operation button 8L and an operation button 20L are provided on the left part of the front surface. The operation buttons 20R and 20L are disposed below the operation buttons 8R and 8L, respectively. The operation buttons 20R and 20L are so-called trigger buttons.

The control of the mobility of the movable member according to the present disclosure may be applied to these cross keys, operation buttons, and trigger buttons. That is, according to the present disclosure, one or more of the cross key, the operation button, and the trigger button may be configured as the operation input device according to the present disclosure configured to control the mobility of the movable member.

When using the operation input device 500, the user operates the above-described various buttons while holding the grip portions 512L and 512R with the left and right hands. The operation input device 500 is a device used by the user in the game play, and is configured to transmit a signal corresponding to the operation performed on the various buttons described above to the game machine. The number and type of buttons and the shape of the operation input device are not limited to those illustrated in these drawings. For example, the operation input device 500 may be configured to be held by one hand of the user. For example, the number of grip portions may be one. Furthermore, the operation input device may include one so-called flight stick instead of the analog stick.

The operation input device of the present disclosure may be configured as, for example, a controller of such a game machine, or may be configured as one unit included in the controller of the game machine. By applying the present disclosure to a controller of a game machine,

### (6) Modification (Mobility Control by Inclined Surface)

In the operation input device described in (1) above, the contact surface between the movable member and the DEA (or the contact member) is provided in a direction substantially parallel to the moving direction of the movable member. In the present disclosure, the contact surface between the movable member and the DEA (or the contact member) may not be substantially parallel to the moving direction of the movable member, and may be inclined with respect to the moving direction. This will be described below with reference to FIGS. 1D and 1E.

In the operation input device 130 illustrated in FIG. 1D, a contact member 135 having a surface S3 inclined with respect to the moving direction of the movable member 131 is provided on the surface of the DEA 102. The contact member 135 is fixed to the surface of the DEA 102. A surface that comes into contact with the contact member 135 with the movement of the movable member 131 is provided so as to be substantially parallel to the surface S3.

In the operation input device 140 illustrated in FIG. 1E, an inclined surface S4 is provided in the housing 143. Then, the DEA 102 is provided on the surface S4. As a result, the contact surface between the movable member and the DEA (or the contact member) is inclined with respect to the moving direction of the movable member. A surface in contact with the DEA 102 along with the movement of the movable member 141 is provided so as to be substantially parallel to the surface S4.

As in the operation input devices 130 and 140 illustrated in FIGS. 1D and 1E described above, the contact surface between the movable member and the DEA (or the contact member) may be inclined with respect to the moving direction of the movable member. Even if the contact surface is inclined as described above, the effects of the present disclosure are exhibited.

### (7) Modification (Adjustment of Movable Range)

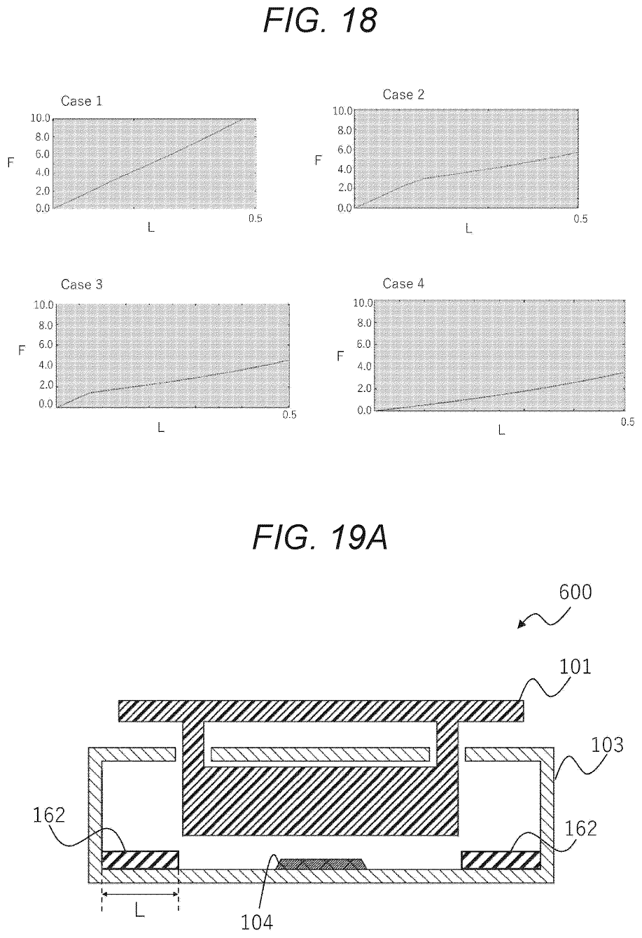

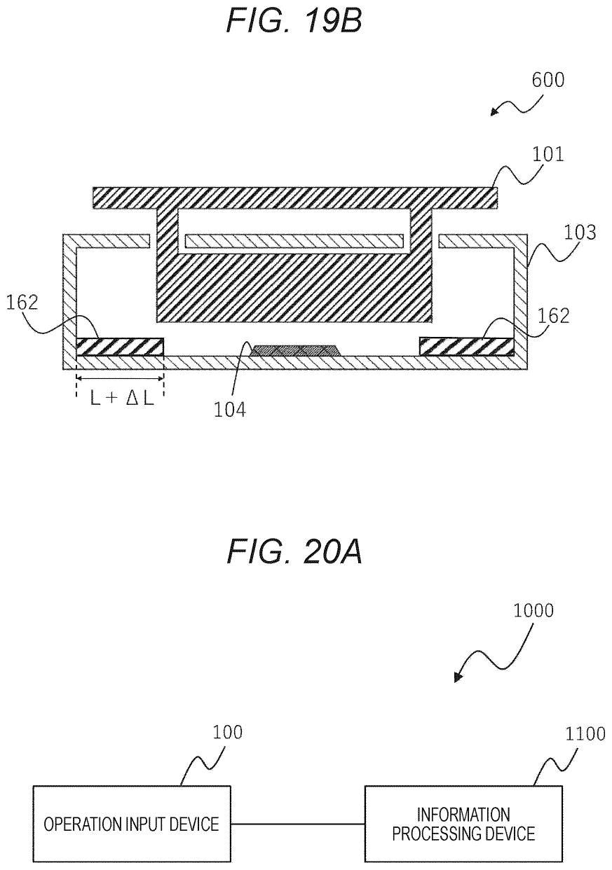

In the operation input device described in (1) above, the frictional force between the movable member and the DEA (or the contact member) is adjusted, or the presence or absence of friction therebetween is adjusted. In the present disclosure, the DEA may be configured such that a movable range of the movable member is adjusted. That is, the DEA may control the mobility of the movable member by adjusting the movable range. This will be described below with reference to FIGS. 19A and 19B.

In the operation input device 600 illustrated in FIG. 19A, the DEA 162 is provided on the surface on which the motion detection sensor 104 is provided. A length of the DEA 162 in a direction parallel to a surface on which the motion detection sensor 104 is provided is L.

In the state illustrated in the drawing, as described above with reference to FIGS. 1A and 1B in (1), the movable member 101 can come into contact with the motion detection sensor 104 by being pushed by the user.

As illustrated in FIG. 19B, the DEA 162 extends in a direction parallel to the surface on which the motion detection sensor 104 is provided by application of a voltage, and its length becomes L+ΔL. In a case where the movable member 101 is extended in this manner, the movable member cannot move to a position where the movable member comes into contact with the motion detection sensor 104 even if the movable member is pushed by the user, and cannot come into contact with the motion detection sensor 104.

Alternatively, the DEA may be fixed to a surface on which the motion detection sensor 104 is provided. Then, the movable range of the movable member may be controlled by extending or contracting the DEA in a direction parallel to the moving direction of the movable member according to the presence or absence of voltage application to the DEA. For example, the extension may prevent the movable member from coming into contact with the motion detection sensor, and the contraction may enable the movable member to come into contact with the motion detection sensor.

As described above, the operation input device of the present disclosure may be configured to control the movable range of the movable member by the DEA.

### (8) Examples

It was verified by finite element method (FEM) analysis that the slidability was changed by the drive of the DEA. The model used for the FEM analysis is illustrated in FIG. 15. In the drawing, a DEA 602 is in contact with a movable member 601 via a surface member 605. The DEA 602 is assembled in a prestrained state such that the surface member 605 has a contact pressure with respect to the movable member 601. Further, a foam material 606 is disposed in the moving direction of the movable member 601.

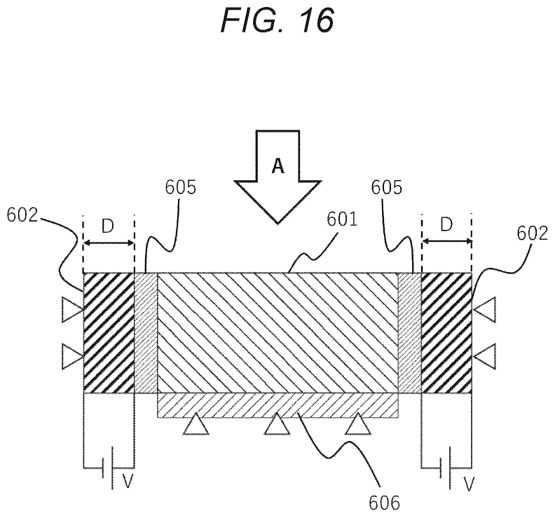

As illustrated in FIG. 16, the DEA 602 is driven in a direction in which the width D of the DEA contracts in response to application of the voltage V, and generates a contraction force in the direction. That is, the frictional force between the movable member 602 and the surface member 605 is reduced by the application of the voltage.

Note that, in this FEM analysis, it is set that the generated force derived from the Maxwell formula illustrated in the following formula is applied to the surface of the DEA 602 instead of simulating the application of voltage.

$$Generated force P ∝ {ε ( \frac{V}{d} )}^{2} \qquad [ Math . 2 ]$$

The conditions for each component in the FEM analysis were as follows.
DEA: Young's modulus of 1 MPa, thickness of 2 mm, relative permittivity of elastomer layer of 5.5
Foam material: Young's modulus 0.05 MPa, thickness 1 mm
Friction coefficient between surface member and movable member: 0.5
Contact pressure between surface member and movable member: 0.044 MPa (during assembly)

For the following four cases, the force of pushing the movable member 601 and the amount of pushing the movable member 601 in a case where the movable member 601 was pushed in the direction of the arrow A were tracked.
Case 1: No voltage is applied, and the movable member 601 is fixed to the surface member 605
Case 2: No voltage is applied, and the movable member 601 is not fixed to the surface member 605
Case 3: Voltage is applied, and the movable member 601 is not fixed to the surface member 605
Case 4: Voltage higher than Case 3 is applied, and the movable member 601 is not fixed to the surface member 605

The voltage, the generated force converted from the voltage, and the friction coefficient between the movable member 601 and the surface member 605 in these four cases are illustrated in Table 1 below.

TABLE 1

| | Voltage | Generated force | Friction |
|---|---|---|---|
| | (MV/m) | (MPa) | coefficient |
| Case 1 | 0 | 0 | ∞ |
| Case 2 | 0 | 0 | 0.5 |
| Case 3 | 21.3 | 0.022 | 0.5 |
| Case 4 | 30 | 0.044 | 0.5 |

In Cases 1 and 2, no voltage is applied to the DEA 602. Therefore, the generated force applied to the surface of the DEA 602 is 0 MPa. In Cases 3 and 4, since a voltage is applied, a generated force corresponding thereto is applied to the surface of the DEA 602.

In addition, in Case 1, since the movable member 601 is fixed to the surface member 605, the friction coefficient between them is infinite. The friction coefficient in Cases 2 to 4 is 0.5.

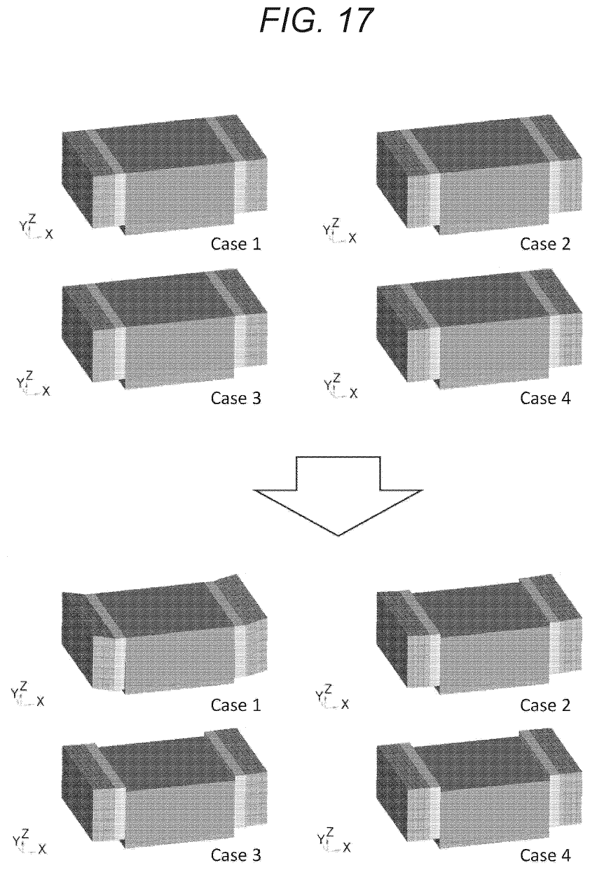

Simulation results in these four cases are illustrated in FIGS. 17 and 18.

FIG. 17 illustrates the shapes of the models before and after the pushing in these four cases. The upper part of FIG. 17 illustrates a state before being pushed, and the lower part of the drawing illustrates a state where being pushed. In Case 1, since the movable member 601 is fixed to the surface member 605, the movable member 601 and the surface member 605 move together with the pushing, and the DEA 602 is deformed after the pushing.

In Cases 2 to 4, since the movable member 601 is not fixed to the surface member 605, the movable member 601 and the surface member 605 are displaced by the pushing.

FIG. 18 is a graph illustrating the relationship between the force F (unit: N) for pushing the movable member 601 and the amount L (unit: mm) by which the movable member 601 is pushed in these four cases.

In Case 1, since the movable member 601 is fixed to the surface member 605, the force required to push the movable member 601 is higher than that in other cases.

In Case 2, since the movable member 601 is not fixed to the surface member 605, the inclination is changed in the middle of the graph, and it can be seen that the movable member 601 starts to slide with respect to the surface member 605.

In Case 3, it can be seen that the movable member 601 starts to slide with respect to the surface member 605 at the time point of the pushing amount smaller than that in Case 2. That is, it can be seen that since the generated force of the DEA 602 is larger than that in Case 2, the contact pressure further decreases and the frictional force decreases.

In Case 4, since the DEA 602 has a generated force corresponding to the contact pressure at the time of assembly, the movable member 601 starts to slide with respect to the surface member 605 from the beginning of the pushing. In Case 4, the movable member 601 moves with a smaller force than in Case 3.

From the above results, it can be seen that the force required for pushing the movable member decreases due to the contraction of the DEA. In addition, it can also be seen that the timing at which the movable member starts to slide can be adjusted by the contraction force of the DEA. Therefore, it can be seen that the slidability and the sense of resistance of the movable member of the operation input device can be controlled by using the deformation of the DEA.

### 3. Second Embodiment (Information Processing System)

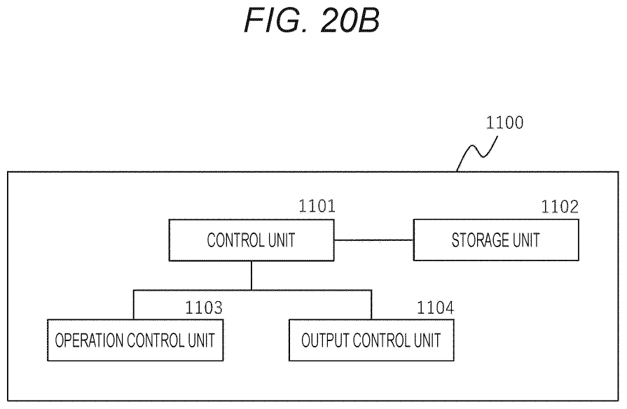

The present disclosure also provides an information processing system including the operation input device described in the above 2. An example of the information processing system will be described with reference to FIGS. 20A and B.

An information processing system 1000 according to the present disclosure may include, in addition to the operation input device 100 according to the present disclosure, an information processing device 1100 configured to transmit a signal (electric signal) for controlling mobility of the movable member to the operation input device. The information processing device 1100 can control the operation input device 100 such that a predetermined voltage is applied to the DEA 102 of the operation input device.

Furthermore, the information processing device may be configured to receive a signal (electrical signal) generated by a user operation on the operation input device. The signal may be, for example, a signal generated when the motion detection sensor 104 detects the motion of the movable member 101.

The information processing device 1100 and the operation input device 100 may be connected by an arbitrary connection method, for example, may be connected via a USB cable or the like. A signal transmitted or received between the information processing device and the operation input device may be appropriately set by a person skilled in the art such that a predetermined voltage is applied to the DEA.

The information processing device 1100 may be, for example, an information processing device capable of executing a game, and may be a so-called game machine. In this case, the operation input device 100 may be a controller of the game machine.

The configuration of the information processing device 1100 may be appropriately set by a person skilled in the art, and for example, as illustrated in FIG. 20B, may include a control unit 1101, a storage unit 1102, an operation control unit 1103, and an output control unit 1104.

The control unit 1101 may be, for example, a program control device such as a CPU, and may operate according to a program stored in the storage unit 1102. For example, in a case where the information processing device 1100 is a game machine, the control unit 1101 can be configured to execute an application of a game. When receiving a signal input by a user operation on the operation input device 100 from the operation control unit 1103, the control unit 1101 can execute predetermined processing on the basis of the signal.

The storage unit 1102 may be, for example, a memory device or a hard disk drive, and may hold a program executed by the control unit 1101.

The operation control unit 1103 is connected to the operation input device 100 by a predetermined connection method (for example, communicably in a wireless or wired manner), receives a signal indicating the content of the user operation on the operation input device 100 from the operation input device 100, and transmits the signal to the control unit 1101.

The output control unit 1104 may be connected to a display device of a television, a monitor, or a head mounted display, and outputs audio and/or video signals to these display devices according to an instruction input from the control unit 1101.

The present disclosure can also adopt the following configurations.
[1]
An operation input device including:
a movable member that moves by a user operation; and
a dielectric elastomer actuator that controls mobility of the movable member.
[2]
The operation input device according to [1], in which the dielectric elastomer actuator controls the mobility to adjust a sense of resistance to movement of the movable member.
[3]
The operation input device according to [1] or [2], in which the dielectric elastomer actuator is configured to adjust a frictional force against movement of the movable member.
[4]
The operation input device according to [1] or [2], in which the dielectric elastomer actuator is configured to adjust a movable range of the movable member.
[5]
The operation input device according to any one of [1] to [4], in which the operation input device is configured to adjust the mobility of the movable member in stages.
[6]
The operation input device according to any one of [1] to [5], in which the movable member is movable to change a position of the movable member with respect to a housing of the operation input device.
[7]
The operation input device according to any one of [1] to [6], further including
a contact member that is in contact with or is disposed to be able to contact the movable member, in which
the dielectric elastomer actuator controls the mobility of the movable member via the contact member.
[8]
The operation input device according to any one of [1] to [7], in which the contact member is provided on a surface of the dielectric elastomer actuator.
[9]
The operation input device according to any one of [1] to [8], further including a motion detection sensor that detects a motion of the movable member.
[10]
The operation input device according to [9], in which the operation input device outputs a signal generated on the basis of motion detection by the motion detection sensor as a signal related to an input operation.
[11]
The operation input device according to any one of [1] to [10], in which the operation input device is a button-type, wheel-type, ball-type, or joystick-type operation input device.
[12]
An information processing system including an operation
input device including:
a movable member that moves by a user operation; and
a dielectric elastomer actuator that controls mobility of the movable member.
[13]
The information processing system according to [12], further including an information processing device configured to transmit a signal for controlling the mobility of the movable member to the operation input device.

Although the embodiments and examples of the present disclosure have been specifically described above, the present disclosure is not limited to the above-described embodiments and examples, and various modifications based on the technical idea of the present disclosure are possible.

For example, the configurations, the methods, the steps, the shapes, the materials, the numerical values, and the like described in the embodiments and examples described above are merely examples, and different configurations, methods, steps, shapes, materials, numerical values, and the like may be used as needed. In addition, the configurations, methods, steps, shapes, materials, numerical values, and the like of the above-described embodiments and examples can be combined with each other without departing from the gist of the present disclosure.

Furthermore, in the present specification, a numerical range indicated by using “to” indicates a range including numerical values described before and after “to” as the minimum value and the maximum value, respectively. In the numerical ranges described in stages in the present specification, the upper limit value or the lower limit value of a numerical range of a certain stage may be replaced with the upper limit value or the lower limit value of a numerical range of another stage.

### REFERENCE SIGNS LIST

100 Operation input device
101 Movable member
102 Dielectric elastomer actuator
103 Housing
104 Motion detection sensor

1. An operation input device comprising:
a movable member that moves by a user operation; and
a dielectric elastomer actuator that controls mobility of the movable member.

2. The operation input device according to claim 1, wherein the dielectric elastomer actuator controls the mobility to adjust a sense of resistance to movement of the movable member.

3. The operation input device according to claim 1, wherein the dielectric elastomer actuator is configured to adjust a frictional force against movement of the movable member.

4. The operation input device according to claim 1, wherein the dielectric elastomer actuator is configured to adjust a movable range of the movable member.

5. The operation input device according to claim 1, wherein the operation input device is configured to adjust the mobility of the movable member in stages.

6. The operation input device according to claim 1, wherein the movable member is movable to change a position of the movable member with respect to a housing of the operation input device.

7. The operation input device according to claim 1, further comprising
a contact member that is in contact with or is disposed to be able to contact the movable member, wherein
the dielectric elastomer actuator controls the mobility of the movable member via the contact member.

8. The operation input device according to claim 7, wherein the contact member is provided on a surface of the dielectric elastomer actuator.

9. The operation input device according to claim 1, further comprising a motion detection sensor that detects a motion of the movable member.

10. The operation input device according to claim 9, wherein the operation input device outputs a signal generated on a basis of motion detection by the motion detection sensor as a signal related to an input operation.

11. The operation input device according to claim 1, wherein the operation input device is a button-type, wheel-type, ball-type, or joystick-type operation input device.

12. An information processing system comprising an operation input device, the operation input device including:
a movable member that moves by a user operation; and
a dielectric elastomer actuator that controls mobility of the movable member.

13. The information processing system according to claim 12, further comprising an information processing device configured to transmit a signal for controlling the mobility of the movable member to the operation input device.
